(19) United States
(12) Patent Application Publication
(10) Pub. No.: US 2024/0246798 A1
(43) Pub. Date: Jul. 25, 2024

(54) PIECE LEVEL DATA COLLECTION SYSTEM FOR GATHERING FREIGHT DIMENSIONS AND RELATED INFORMATION

(71) Applicant: INNOVATIVE LOGISTICS, LLC, Fort Smith, AR (US)

(72) Inventors: Andrew Karl Marcum, Greenwood, AR (US); Michael Allen Linn, Fort Smith, AR (US); Earideth Eugene Anderson, Greenwood, AR (US)

(21) Appl. No.: 18/417,594

(22) Filed: Feb. 6, 2024

Related U.S. Application Data
(60) Provisional application No. 63/440,202, filed on Jan. 20, 2023.

(51) Int. Cl. B66F 9/075; G06T 7/00; G06V 20/62; G06V 30/10; G06K 7/14

(52) U.S. Cl. CPC B66F 9/0755; B66F 9/07504; B66F 9/07581; G06T 7/0002; G06V 20/62; G06V 30/10; G06K 7/1404

(57) ABSTRACT

The piece level data collection (PLDC) system is used to identify freight and gather freight dimensions (Length×Width×Height) passively or semi-passively. At least one upper sensor and one lower sensor capture the measurements while the freight is being conveyed by a conveyance vehicle during a move event. Final dimensions for the freight are determined and communicated to a PLDC module for storage.

### CROSS-REFERENCE TO RELATED APPLICATIONS

This application claims priority to U.S. Provisional Application Ser. No. 63/440,202, filed Jan. 20, 2023, the entire contents of which are hereby incorporated by reference in their entirety.

### FIELD OF THE INVENTION

The present invention relates to a piece level data collection system (PLDC) to identify freight and gather the freight dimensions (Length×Width×Height) passively or semi-passively.

### BACKGROUND

Gathering freight dimensions for shipping and handling is typically done with either a tape measure or using a stationary dimensioning system. Using a tape measure requires the forklift operator getting off the forklift, measuring the freight, getting back on the forklift, and entering the dimensions into a tablet. These measurements can often be inaccurate because they rely on the skill of the forklift operator and they cannot account for irregular shaped freight.

Stationary dimensioning system systems utilize light curtains and/or other sensors and require the forklift operator to drive through or under the stationary dimensioning system. Stationary dimensioning systems require dedicated space that could be utilized for staging freight and may inhibit movement of the forklifts. Additionally, the forklift operator must often go out of their way to drive to and from the stationary dimensioning system. Accordingly, a need exists for a freight dimensioning system that minimizes interference of the forklift operators that can capture the same level of detail as stationary dimensioning systems. The data gathered by the freight dimensioning system can also be leveraged for other purposes such as damage detection, label recognition, etc.

### SUMMARY

The PLDC system utilizes equipment installed on forklifts to collect, process, and share important information about freight during its handling. The type of information gathered may include dimensions of the freight, details found on visible freight labels, and photos of the freight at the time of both pickup and drop-off. To do this, the PLDC system uses 3D depth sensors, cameras, and an onboard computer processing unit (CPU). Once the data is captured, it can be sent to the forklift operator in real-time to help them with their current tasks or forwarded to a server for more in-depth analysis and business use cases.

The PLDC system enables semi-passive or passive freight dimensioning for capturing accurate freight dimensions with minimal interference in the forklift operator's routine. Accurate freight dimensions are critical for many applications, such as optimizing storage and warehouse space, ensuring safe and efficient transportation, calculating cube-based pricing, facilitating faster customs clearance, and meeting regulatory and carrier requirements.

The process of capturing this data according to the invention only requires lifting freight off ground for a couple seconds to a predetermined or calculated height at some point during freight move. This is less impactful than static or drive-through dimensioners, which require the freight to pass through a specific location, often causing operational bottlenecks.

The PLDC system can also be utilized for void space optimization, utilizing depth information to detect and quantify unused space on pallets. This allows for improved storage and transport during load construction, resulting in potential savings in warehousing and transportation costs. Companies can utilize any identified void space to offer incentives, such as adding extra pieces to pallets without additional shipping fees, capitalizing on optimized space and enhancing the overall customer experience.

Further, the PLDC system automates image capture at both initial and final destinations of each move. This allows for the creation of a visual timeline, tracing the journey of freight through logistics networks. The images can be utilized to detect anomalies like damage, missing freight, or load shift. Any damage or missing freight can be identified early and addressed before the freight reaches its final destination.

The images captured by the PLDC system can be utilized to capture and identify freight labels. This allows the PLDC system to automatically associate the unique identifier (e.g., barcode, data matrix codes, QR codes, etc.) on the freight with the freight dimensions. Optical character recognition can be utilized to extract any additional information on the freight labels or the freight itself (e.g., manufacturer name, product name, etc.). This reduces the need for the forklift operators to manually scan and log each piece of freight as it is moved.

The information captured by the PLDC system can also be analyzed provide insight in metrics like the idle periods of forklifts and the average duration for moving freight. The data collected by the PLDC system can also be formatted on-the-fly for integration with any existing systems that customers may utilize.

### BRIEF DESCRIPTION OF THE DRAWINGS

FIG. 1 depicts a system diagram of the PLDC system according to an embodiment of the invention.

FIGS. 2A-21 depicts an example user interface screens for a forklift operator.

FIG. 3 depicts an example forklift outfitted with upper sensors and lower sensors.

FIG. 4 depicts an example arrangement for an upper sensor.

FIG. 5 depicts an example arrangement for a lower sensor.

FIG. 6 depicts a side view of an example forklift outfitted with the upper sensor and lower sensor of FIGS. 4 and 5.

FIG. 7 depicts a flowchart for creating a move event and calculating dimensions of freight conveyed during the move event.

FIG. 8 depicts a flowchart for performing system checks and boundary detection prior to calculating dimensions for freight.

FIG. 9 depicts an example rotation correction for freight.

FIG. 10 depicts a plot showing the “knee” when plotting measurement along an axis vs. point pairs removed during the knee-based noise detection algorithm.

FIG. 11 depicts a consolidated point cloud depicting points from a consolidated point cloud to be removed after noise detection.

FIG. 12 depicts an example label collage captured by the upper sensors or lower sensors.

FIGS. 13A-13D depicts the process for void space optimization according to the present invention.

### DETAILED DESCRIPTION

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

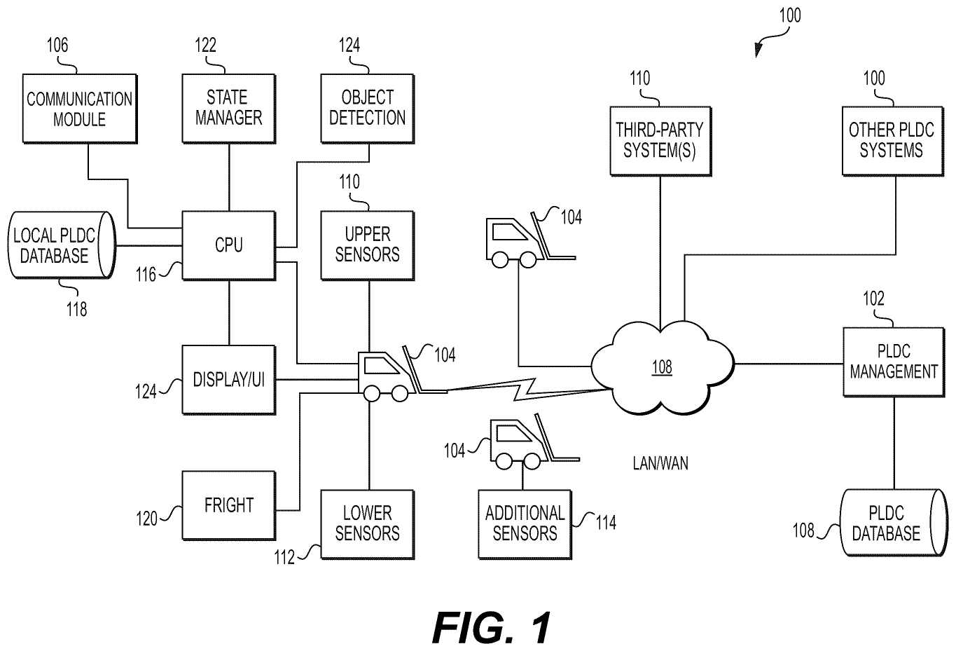

FIG. 1 depicts a system diagram showing the components of PLDC system 100. PLDC management module 102 stores data gathered by forklifts 104 during move events (e.g., moving freight 120 from point A to point B). Each forklift 104 comprises one or more communication modules 104 to wirelessly communicate with PLDC management module 102 over LAN/WAN (e.g., Internet) 108. The communication modules 104 may be configured to communicate with PLDC management module 102, or each other, utilizing any known wireless communication methods such as Wi-Fi, cellular, satellite, Bluetooth, etc.

The PLDC management module 102 may be in communication with other PLDC systems 100 having similar configurations to share the data gathered and stored in PLDC database 108 (e.g., freight dimensions, freight identification, images, etc.) as will be explained later. Alternatively, a single PLDC management module 102 may be utilized system wide (e.g., a cloud-based system). Further, PLDC management module 102 can communicate with third-party systems 110 to share the data stored in PLDC database 108. The PLDC management module 102 can format the data so it can be integrated directly into the third-party systems 110 or the third-party systems 110 can request the data through an application programming interface (API).

Each forklift 104 is outfitted or retrofitted with a plurality of sensors which can be generally categorized into upper sensors 110, lower sensors 112, and additional sensors 114. In FIG. 1, only one forklift 104 is depicted showing all components and sensors but it is to be understood that each forklift 104 that interfaces with PLDC system 100 preferably comprises similar or equivalent components. The upper sensors 110 and lower sensors 112 generally comprise depth sensors and/or digital cameras to capture three-dimensional (3D) spatial data about the surroundings of forklift 104. This setup allows for the use of any technology that aids in the gathering of 3D depth information. This includes, but is not limited to, Time of Flight, LiDAR, and stereoscopic vision sensors. The data gathered through these methods is then converted into a 3D point cloud through the use of an onboard computer processing unit (CPU) 116. This point cloud acts as a virtual representation of the physical world, accurately reflecting the geometric and spatial characteristics of the objects and surroundings it's designed to represent. From here, the point cloud is analyzed by CPU 116 to extract data about the associated piece of freight 120.

Additional sensors 114 may be utilized to collect additional information about freight 120 and the collected information can be added to the move event. For example, some forklifts 104 are outfitted with weight sensors that can be used to measure the weight of freight 120 after it is lifted. Other forklifts 104 include load balance sensors that detect if the lifted freight is stable/unstable by monitoring the load distribution on the tines of the forklift 104.

Each forklift 104 further comprises local PLDC database 118 for storing the data gathered by upper sensors 110, lower sensors 112, additional sensors 114, and any computation results from CPU 116. For example, the communication modules 106 may be configured to transmit data from local PLDC database 118 to PLDC database 108 at regular intervals or when network bandwidth is available or available to avoid congestion. After the data is transferred from local PLDC database 118 to PLDC database 108 it can be deleted or retained as a backup. Further, local PLDC database 118 is utilized for the temporary storage of data gathered by forklift 104 for later processing by CPU 116. When multiple connections are available, communication module 106 can be programmed to prioritize one communication method and switch to another as a fallback. Moreover, if connectivity is lost, local PLDC database 118 can temporarily store data for later transmission once a connection becomes available again.

CPU 116 serves various functions. Its main role is to manage the coordination of upper sensors 110, lower sensors 112, and additional sensors 114, ensuring they collect data at the same time across all units. Moreover, CPU 116 is also utilized to compile and process the collected point cloud data, extracting the dimensions of the freight 120 carried by forklift 104, and sending pertinent data off-device to PLDC management module 102, among other tasks.

The PLDC system 100 utilizes network connectivity for various purposes. As previously mentioned, data is regularly transmitted from local PLDC database 118 to PLDC database 108. PLDC database 108 may utilize cloud-based storage on-site servers. PLDC management module 102 ensures continuous remote system management capabilities for all forklifts 104, which might include functions like device health monitoring or remote updates.

State manager 122 serves to monitor the state of the forklift 104, as well as compile and organize all data collected on a piece of freight 120 as it is handled. As will be explained in more detail later, the region of space around the forklift forks (herein referred to as “personal space”) is constantly monitored to detect freight 120. If the number of points present within the personal space is above a predetermined threshold, the state manager 122 determines that forklift 104 is “loaded,” otherwise the state is “empty.” Generally, the personal space is an adjustable parameter for each forklift 104. In some embodiments, the personal space extends to the length and width of the forks 310, with the height of the personal space being set to the size of the height of the forklift 104.

When state manager 122 determines that freight 120 is loaded and being handled, a move event data structure is created. This data structure is used to compile all available information that is collected about the given freight 120. The move event data structure includes a universally unique identifier (UUID) for the move event, start and end timestamps, all final dimensions in each axis (length, width height), dimension confidence values, approach photo(s), departure photo(s), detected label information, collages, and/or void space information. The system state is used to determine when a move event starts and stops. Once complete, the finalized move event can be transmitted for storage in PLDC database 108 or further analyzed by CPU 116 (e.g., when the state=empty).

### Display and User Interface

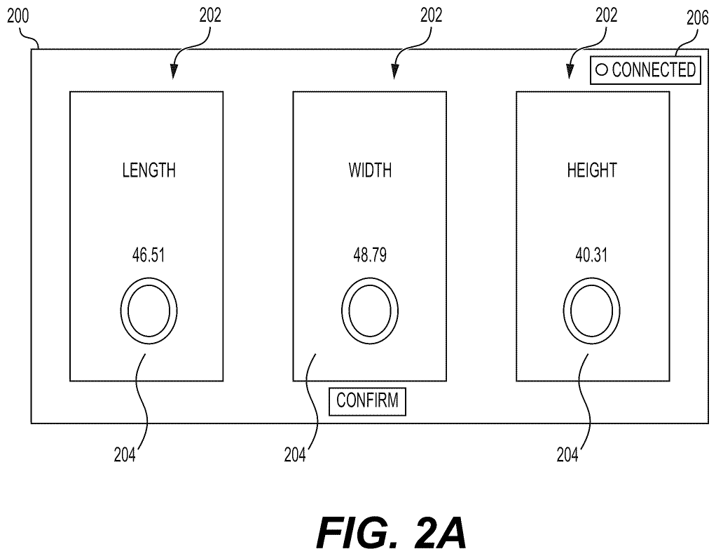

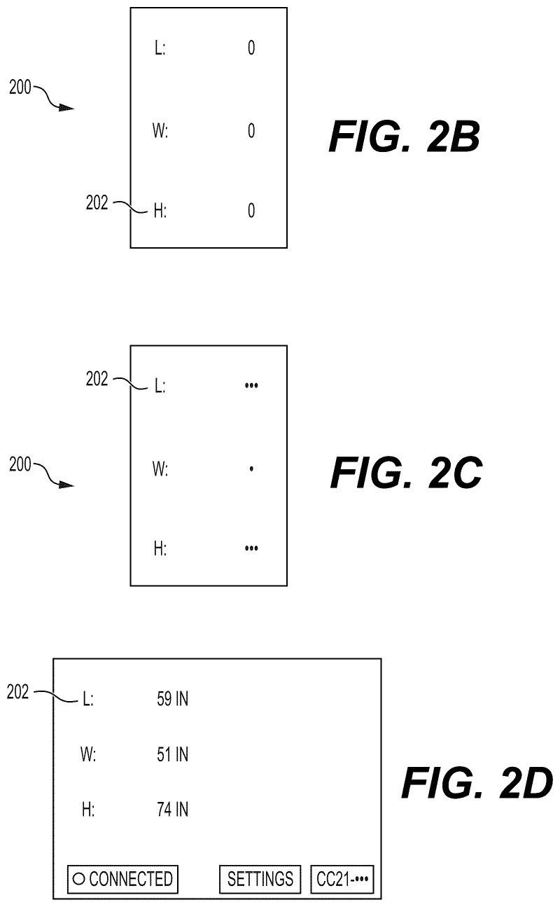

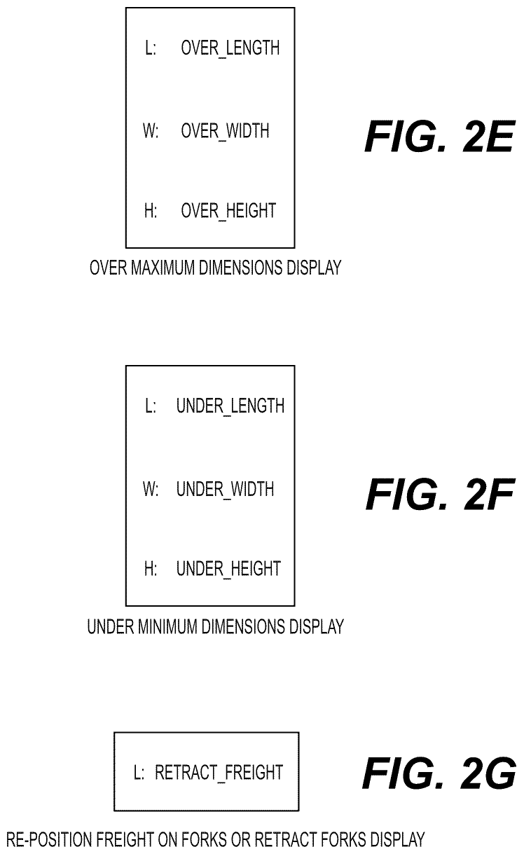

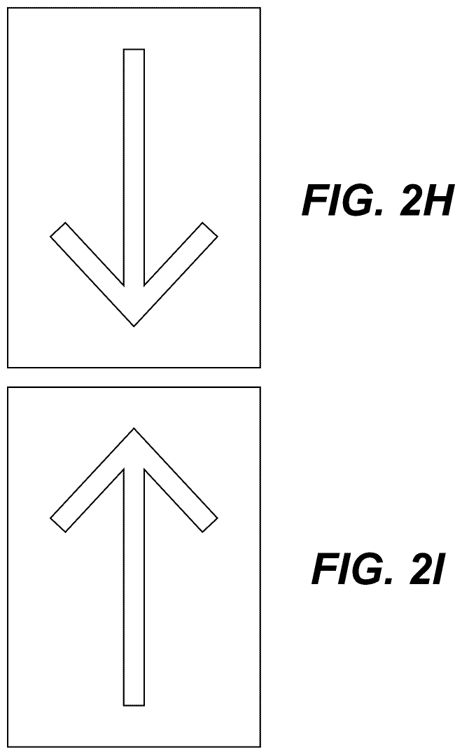

Data produced by CPU 116 or state manager 122 can be transmitted to display 124 for multiple purposes. Example user interface (UI) 200 screens for display 124 are depicted in FIG. 2A-21. The dimensions 202 can be displayed along with an indicator 204 to identify if each calculated dimension is acceptable/not acceptable. An “O” can be used to indicate that a particular dimension is accurate while an “X” can be used to indicate that a particular dimension needs to be adjusted or manually entered. In some embodiments, the indicator 204 can be utilized to show when dimensions are being calculated to the forklift operator. If dimensions 202 cannot be calculated or are miscalculated, an error message can be displayed for a particular dimension in place of a value.

The UI 200 can be used to prompt the forklift operator to perform actions which improve the capabilities of the PLDC system 100, such as prompting them to raise or lower the forks to the appropriate height for capturing dimensions. UI 200 may also include additional information such as network connectivity indicator 206 which can indicate if communication module 106 is in communication with PLDC management module 102 and/or the type and strength of communication available.

A wide variety of UI options for UI 200 may be used depending on the physical interfaces available on the forklift and the information to be displayed. For example, if display 124 is an LCD display, UI 200 can display captured dimensions, system status messages, or prompts to the operator to raise or lower forks. On the other end of the spectrum, display 124 may be implemented on a tablet to allow for an interactive UI 200 with additional information, such as displaying the captured freight images or identified labels from freight 120.

The UI 200 may present different screens depending upon the current status of measurements 202. When the forklift 104 is ready/waiting for a new move event and is ready, a UI screen 200 can be displayed as shown in FIG. 2B (e.g., similar to displaying a zero on a scale before measurements to indicate readiness). While measurements 202 are being calculated, an animation 206 can be displayed as depicted in FIG. 2C for each measurement to indicate that the calculation is in process. Final measurements are displayed for all three dimensions in FIG. 2D. A different color may be used to indicate a confidence level of each of the measurements.

If measurements are over the maximum size (FIG. 2E) or below the minimum size (FIG. 2F), a particular message indicating this may be displayed for each error. If the freight 120 is not positioned correctly on the forks 310, a reposition message may be displayed as depicted in FIG. 2G. UI 200 may also utilize one or more graphical icons as depicted in FIGS. 2H and 21 to indicate to the forklift operator if freight 120 should be lifted or lowered for better measurements. It is important that any instructions provided to the forklift operators are simple and easy to understand to avoid delays.

### Sensor and Sensor Placement

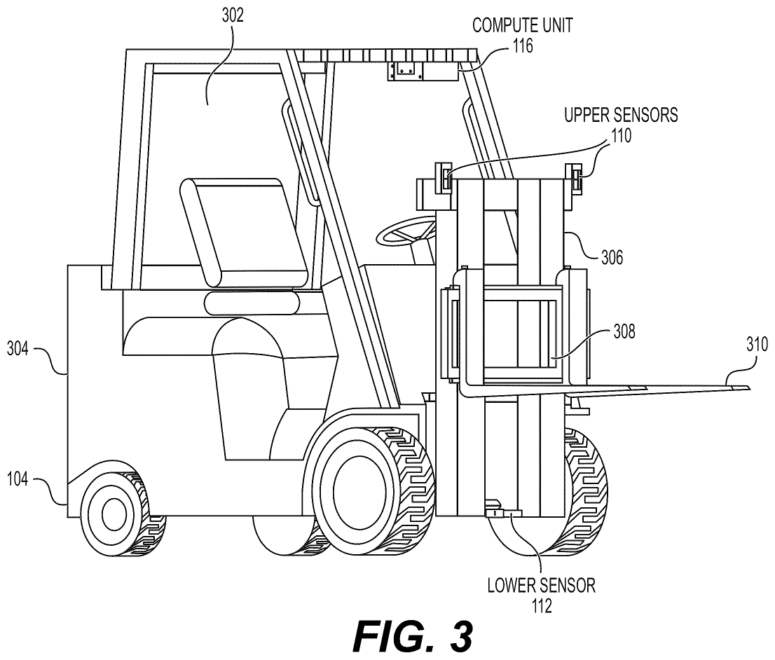

FIG. 3 depicts an example forklift 104 showing example placements for upper sensors 110 and lower sensors 112 according to an embodiment of the invention. Most counter-balanced forklifts 104 include cab 302, counterbalance 304, mast 306, carriage 308, and forks 310. The mast 306 is the upright structure at the front of the forklift 104 that allows the forklift 104 to lift freight 120. The mast 306 can consist of multiple nested rails that extend above the mast's collapsed height. The mast 306 can tilt forwards and backwards in some forklifts 104. Carriage 308 is the frame on the front of the mast 306 that moves vertically with the mast 306 and is where forks 310 or other attachments are mounted. The forks 310 include two tines used for lifting the freight 120.

The upper sensors 110 and lower sensors 112 are mounted to mast 306 and are positioned to monitor freight 120 when elevated on the forks 310 during move events. To meet minimum coverage requirements, lower sensors 112 are positioned near the bottom of the mast 306, while upper sensors 110 are positioned above the freight 120 on mast 306. While these represent basic placement guidelines, sensor number and positioning can be tailored to specific needs. Some mast designs, for instance, might restrict mounting options in terms of sensor count or location. Conversely, for heightened accuracy, adding more sensors with overlapping fields of view (FOV) can enhance resolution.

The forklift 104 depicted in FIG. 3 has a mast 306 which lacks a center lift piston. In this configuration, two upper sensors 110 sensors are placed at the same height at the top of the mast's outer face. A single lower sensor 112 is placed at the center of the bottom of the mast 306. The upper sensors 110 have their field of view (FOV) oriented vertically, leveraging their wider vertical range (compared to horizontal range) to enhance height measurements. The overlapping areas of their coverage enhance measurement accuracy, while the non-overlapping sections extend the horizontal FOV. Conversely, the lower sensor 112, situated centrally, is designed to optimize the observable width. Lower sensor 112 also provides an adequate vertical FOV, essential for gauging depth measurements when freight reaches the stipulated elevation on forks 310.

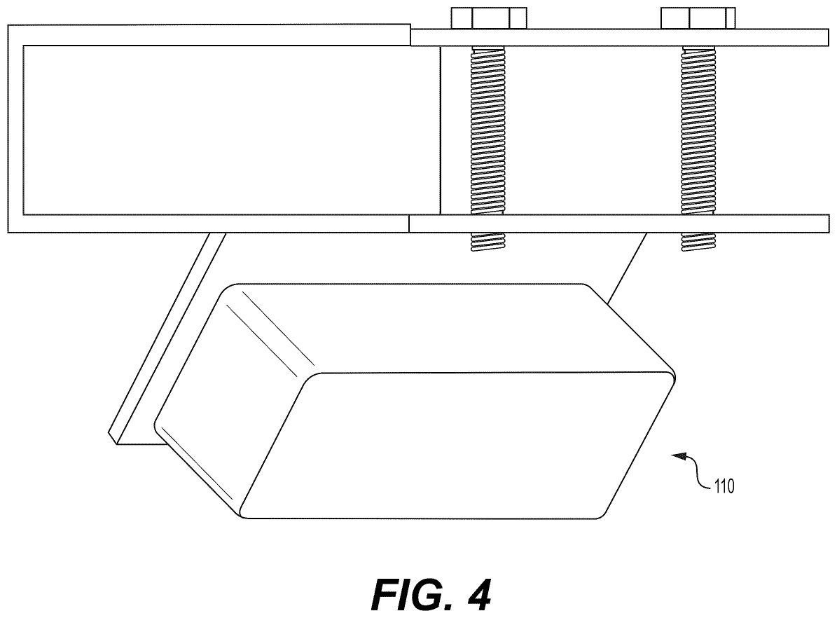

Forklifts 104 having a center lift piston may utilize a single upper sensor 110 and a single lower sensor 112 as depicted in FIGS. 4-6. The upper sensor 110 is mounted in the center of the upper crossbar on the inner mast 306. In this location, the upper sensor 110 will move vertically as the forks 310 are raised and lowered. In this configuration, the upper sensor is angled downwards 30-40 degrees below horizontal.

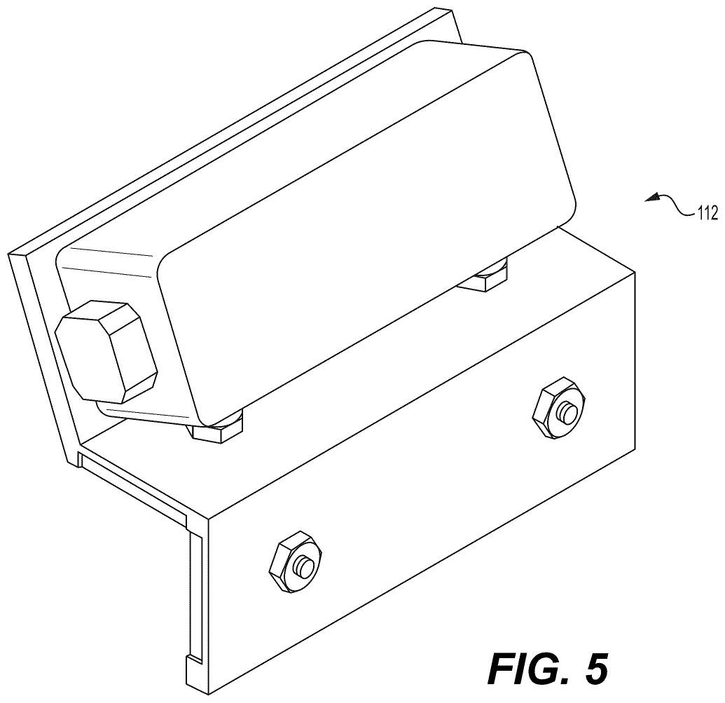

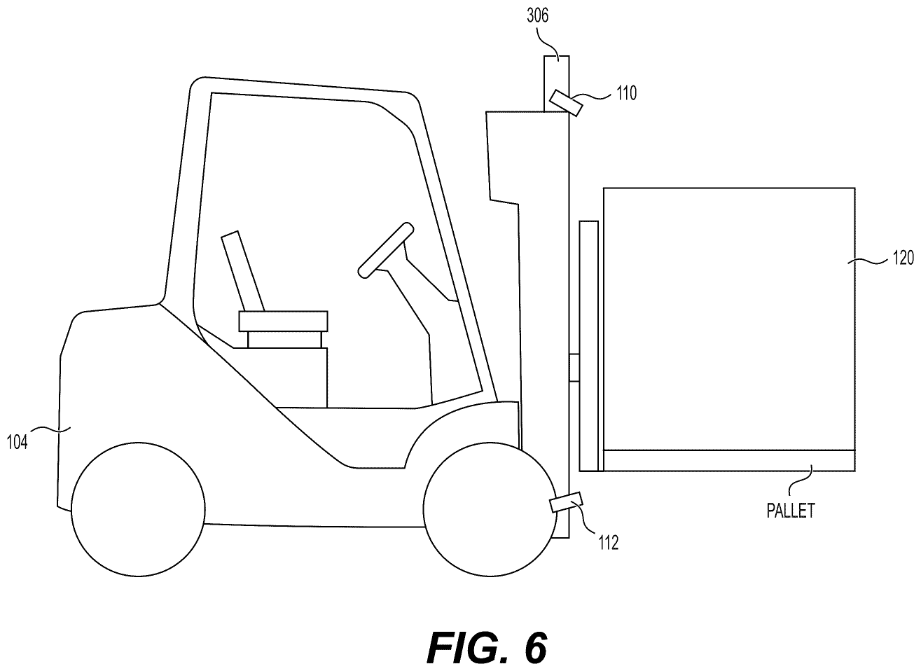

The lower sensor 112, depicted in FIG. 5, is mounted in a center of the lower crossbar on the outer mast 306. When the forks 310 are lowered, this places the lower sensor 112 directly behind the carriage 308. In this location, the lower sensor 112 is stationary as the forks 310 are raised and lowered. The lower sensor 112 here is angled upwards 20-30 degrees above horizontal. FIG. 6 depicts the upper sensor 110 and lower sensor 112 of FIGS. 4 and 5, respectively, mounted to a mast 306 of forklift 104. It should be obvious to one of ordinary skill in the art that the placement and the angling of upper sensor(s) 110 and lower sensor(s) 112 can be adjusted for a specific forklift model to achieve optimal performance.

In some embodiments, a field of view of upper sensors 110 may be 60-80 degrees horizontal, but more particularly 72 degrees horizontal. The field of view of upper sensors 110 may also be 100-110 degrees horizontal, but more particularly 105 degrees horizontal. The fields of view for upper sensors 110 should always overlap to ensure that there are no gaps in detection of the freight 120.

### System State Determination

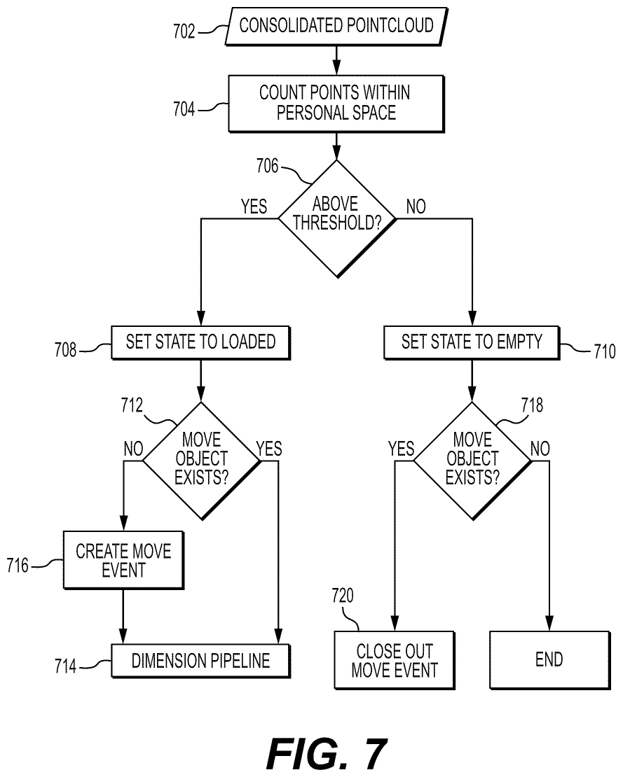

As previously described, state manager 122 regularly evaluates each point cloud formed from the point cloud data captured by upper sensors 110 and lower sensors 122 to determine if the forklift 104 is loaded or empty. As depicted in FIG. 7, a consolidated point cloud is created from the data gathered by the upper sensors 110 and lower sensors 122 at predetermined intervals in step 702. Any points in the point cloud outside the personal space of the forklift 104 are discarded in some embodiments. The number of points falling withing the personal space are counted in step 704. If the number of points is above a predetermined threshold as determined in step 706, the state manager 122 sets the state to loaded in step 708. If the number of points is below the predetermined threshold, the state manager 122 sets the state to empty in step 710.

Clustering may additionally be performed to form groups within the consolidated point cloud. For example, the number of points withing different predefined regions of space in/outside the personal space could be counted and the number of points in each predefined region can be compared to an overall threshold or a threshold unique to that region. Groups that do not have a number of points greater than their respective threshold can be discarded. If the remaining number of groups is above a predefined number or threshold (e.g., 70% remain), it can be determined that the forklift 104 is loaded.

The personal space is a region box used to determine when freight 120 is loaded onto the forks 310 of the forklift 104. The personal space can be calibrated for each forklift model to contain the region between and above the forks 310. The predetermined threshold can be adjusted as needed to avoid false triggering due to noise. Exclusion region boxes may be used to filter out points in areas that the freight 120 cannot be to prevent them from being include in the freight measurements. Examples of exclusion regions may include the region below floor height, the vertical region that the forklift carriage 308 travels through, and the region taken up by the forks 310.

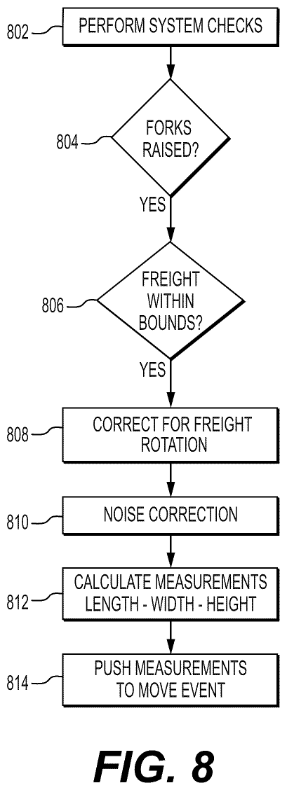

When the state manager 122 sets the state to loaded, the PLDC system 100 next determines if the move object being tracked exists within PLDC database 108 in step 712. If the move object already exists, the freight 120 is tracked using the dimension pipeline 714 as will be described in FIG. 8. If the move object does not currently exist, a move event is first created in step 716 before proceeding to dimension pipeline 714. For example, in some instances, a piece of freight 120 may be picked up and it may be determined ins step 712 that the object being moved does not exist (move object) in PLDC database 108. This prompts the creation of a move object corresponding to the freight 120. After the state is set to empty in step 710 (e.g., freight 120 has been dropped off), the CPU 116 queries if the move object exists in step 718. If the move object exists, the move event is “closed out” (e.g., a corresponding move event is ended) in step 720.

As previously described, creation of a move event in step 716 requires assigning a UUID, a beginning time stamp, and capturing at least one approach image. The state manager 122 constantly monitors the personal space as previously described to determine when a move event ends in step 720. When state manager 122 determines that the move event is/has concluded, an end time stamp is created and at least one departure image is captured.

### Boundary Detection and System Checks

To gather dimensions, the forks 310 must be loaded, the freight 120 must be lifted to a minimum calibrated height to allow for a view of the freight footprint, and the freight 120 must be within the combined fields of view of the upper sensors 110 and lower sensors 112. For each consolidated point cloud gathered during a move event, CPU 116 performs system checks and boundary detection to ensure that the freight 120 being moved can be captured and that it is positioned optimally on the forklift 120 for data gathering as depicted in FIG. 8. These checks may be performed at the start of the move event (e.g., after the first consolidated point cloud is gathered) or at intervals the same or different than the intervals used for gathering the point clouds. This provides for many opportunities for the forklift operator to correct the freight 120 during the move event. The CPU 116 first queries state manager 122 to determine that the forklift is loaded in step 802. Next, the CPU 116 determines if the forks 310 are raised above a predetermined height in step 804.

The point cloud is then analyzed by CPU 112 to determine if the freight 120 being conveyed is within bounds in step 806. Specifically, CPU 112 analyzes each consolidated point cloud to look for data points that are near the edge of the FOV of upper sensors 110 or lower sensors 112. If freight-related points are found on this border, it suggests that some parts of the freight 120 might be outside the FOV and hence, invisible. This scenario would make any measurements taken unreliable.

The CPU 112 may display guidance on the UI 200 in an attempt to correct the point cloud (e.g., FIGS. 2H and 21). When the freight 120 extends below the lower field of view of the upper sensors 110, it will prompt the forklift operator to lift the freight. Conversely, if the freight extends above the upper field of view of the upper sensors 110, it will trigger a prompt for the forklift operator to lower the freight 120.

If the freight 120 extends beyond the left or right boundary of the sensor's field of view, the operator might receive a request to confirm that the freight 120 is centered on the forks 310. However, if the freight 120 oversteps the FOV in two directions at the same time, either vertically or horizontally, capturing dimensions will not be possible. The UI 200 may then prompt the forklift operator to manually enter the dimensions of the freight using traditional methods or to proceed to a stationary dimensioner (if available).

### Rotation Correction

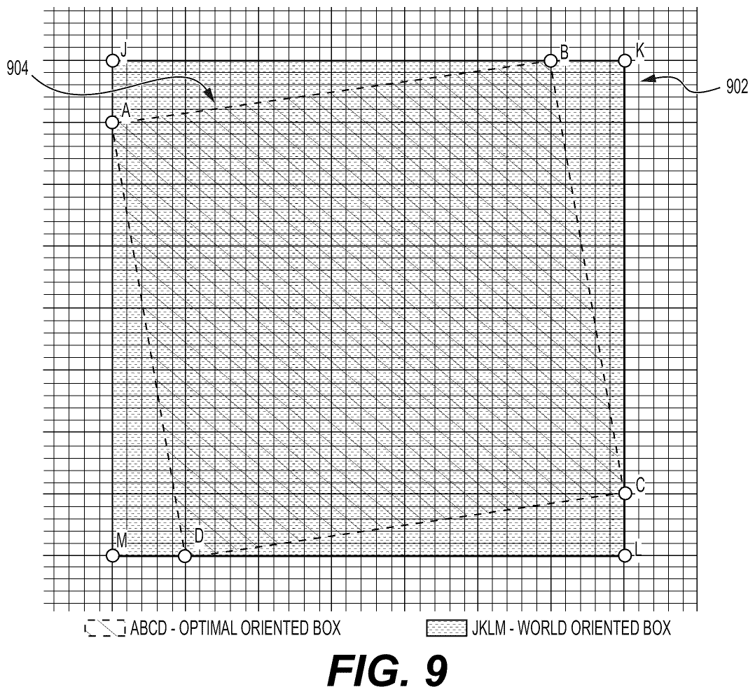

After confirming all the checks in steps 802-806, the CPU 112 assesses whether the freight is rotated on the forks and corrects for the rotation accordingly in step 808. During normal forklift operation, it is common for freight 120 to be shifted and not align with the forklift coordinate frame. In these instances, an axis aligned bounding box would be artificially inflated as depicted in FIG. 9. If the freight 120 is rotated slightly counterclockwise and there was no rotation correction, the boundary would be calculated as world oriented bounding box 902 when the optimal bounding box is boundary box 904.

To address this, a minimum oriented bounding box is found. The minimum oriented bounding box is fixed along the vertical axis such that it remains aligned with the footprint of the freight 120. The bounding box for the freight point cloud is then rotated around the vertical axis until a minimum volume box is found (e.g., plus or minus 10 degrees). The orientation of this box then provides the freight rotation angle and the minimum oriented dimension measurements.

### Noise Correction

After rotation correction, noise correction is performed on the consolidated point cloud in step 810 preferably utilizing a knee-based noise detection algorithm. The knee-based noise detection algorithm utilizes the idea of axis specific point support. A data point is defined as “supported” if its removal causes insignificant changes to the measurements of the encompassing bounding box along a given axis. This method allows for the system to be individually fine-tuned to varying characteristics along each axis, which may emerge from multiple sensors or due to the point dispersion as they recede from the sensor location.

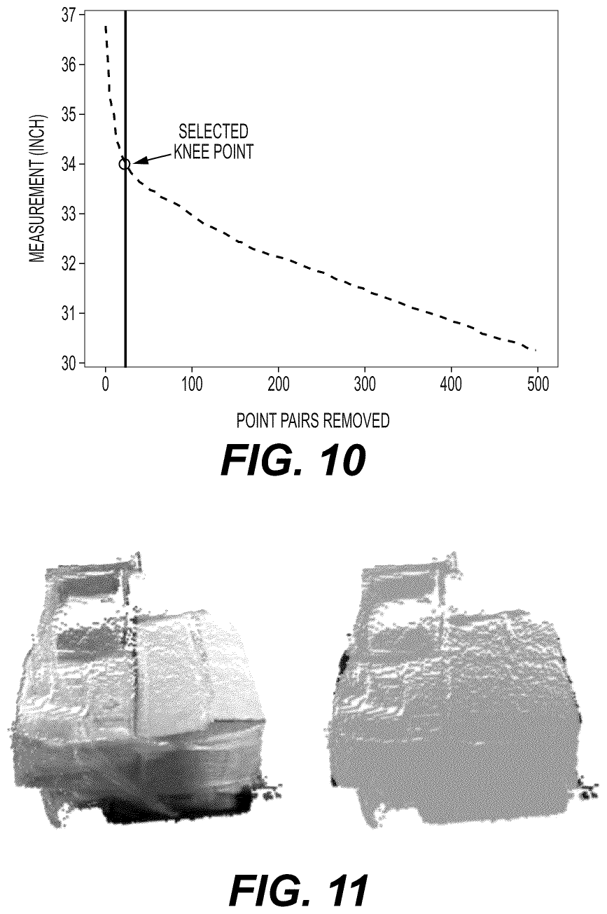

The knee-based noise detection algorithm procedure consists of iteratively eliminating the most extreme pairs of points along a single axis and comparing the resulting new measurement to the previous measurement. If these points are noise, their lack of support would likely yield a significant reduction in the dimension measure. Conversely, if they represent valid points, they are expected to be supported, leading to minor reductions in the measurement. When the measurement along the axis is plotted vs. the number of point pairs removed, a “knee” is visible as depicted in FIG. 10. Removal of points before the knee results in a more drastic change in dimension than after the knee.

In some embodiments, the knee point can be calculated using the algorithm described in V. Satopaa, J. Albrecht, D. Irwin and B. Raghavan, “Finding a “Kneedle” in a Haystack: Detecting Knee Points in System Behavior,” 2011 31st International Conference on Distributed Computing Systems Workshops, Minneapolis, MN, USA, 2011, pp. 166-171, doi: 10.1109/ICDCSW.2011.20. Once the points have been plotted for each dimension, the algorithm normalizes the data and calculates the difference between the plotted/fitted curve and a straight line to identify the knee point as where this difference is greatest (e.g., along the x-axis over a predefined distance of “point pairs removed”). For example, the algorithm may look for the point with the greatest difference (greatest area between them when plotted) from a straight line over 20 point pairs removed.

The reduction in measurement serves as an identifier for noise, as all points leading to a substantial reduction in measurement are considered as noise and are subsequently removed. This process minimizes the likelihood of eliminating authentic points in the data.

From the consolidated point cloud, the points are extracted and organized in ascending order along a specified axis (e.g., x, y, z). The distance between points is then calculated following an outer-to-inner sequence (for instance, pairs such as 1 and N, 2 and N−1, and so forth). The computed distances are then plotted to pinpoint the “knee” point. This knee point represents the transition in the plotted curve from larger to smaller reductions upon the removal of point pairs.

The distance measurement at the knee point is selected as the true measurement. Points before the knee point are removed from the consolidated point cloud. FIG. 11 depicts an example of a point cloud processed utilizing the described knee-based detection noise algorithm. The dark points around the edge of the freight 120 were identified as noise and are removed prior to calculating the final dimensions.

### Dimension Calculation

After the checks and preprocessing described steps 802-810 have been performed, the PLDC system 100 is left with a consolidated point cloud representing the freight 120 (fore each predetermined interval). This single consolidated point cloud has had noise removed and has been digitally rotated to align with the axis of coordinate system of the forklift 104. From here, dimensions can be calculated directly by placing an axis-aligned bounding cube around the final consolidated point cloud and taking the box length, width, and height in step 812.

All measurements captured in the above-described processes are stored until the move event ends. At the end of the move event, final dimensions are selected by eliminating the outliers and taking the mean of inliers. For each axis, an average value of each measurement is calculated and any measurements that extend more than three standard deviations away from the average value for that dimension are eliminated. Once these outliers are removed, the final dimensions are determined by calculating the mean of the remaining measurements for each axis in step 812. For example, during a 30 second move event 150 separate point clouds may be captured, generating 150 different measurements for length, width, and height. At the end of the move event, it may be determined that 10 measurements could be eliminated as outliers. The remaining 140 are averaged to provide the final measurement to the operator and database. The number of measurements that are eliminated for each axis (length, width, and height) is dependent on the data gathered. This methodology enhances resilience of PLDC system 100 against less accurate measurements, which might be caused by external factors like unwanted objects infringing on the dimensioning space, or internal limitations such as the accuracy of the upper sensors 110 or lower sensors 112. After the final dimensions are calculated, the move event is finalized in step 814 and is transmitted to PLC database 108 when communication is available as has already been described.

### Label Detection

The CPU 112 enables the implementation and operation of machine learning models and optical character recognition to identify and extract visible labels, text, or other identifiers on freight. Once identified, multiple methods can be employed to extract information, including Optical Character Recognition to read text as well as decoding information from a variety of barcodes, QR codes, data matrices, and more. The label detection process can be carried out on the approach and departure images that form part of the move event and any extracted information can be added to the move event with the appropriate label. This method allows the PLDC system 100 to collect and supply the maximum amount of information to either the forklift operator or the associated business unit. Particularly, finding unique identifiers for the freight that can be correlated with the collected dimensions is critical to maximizing the system's value.

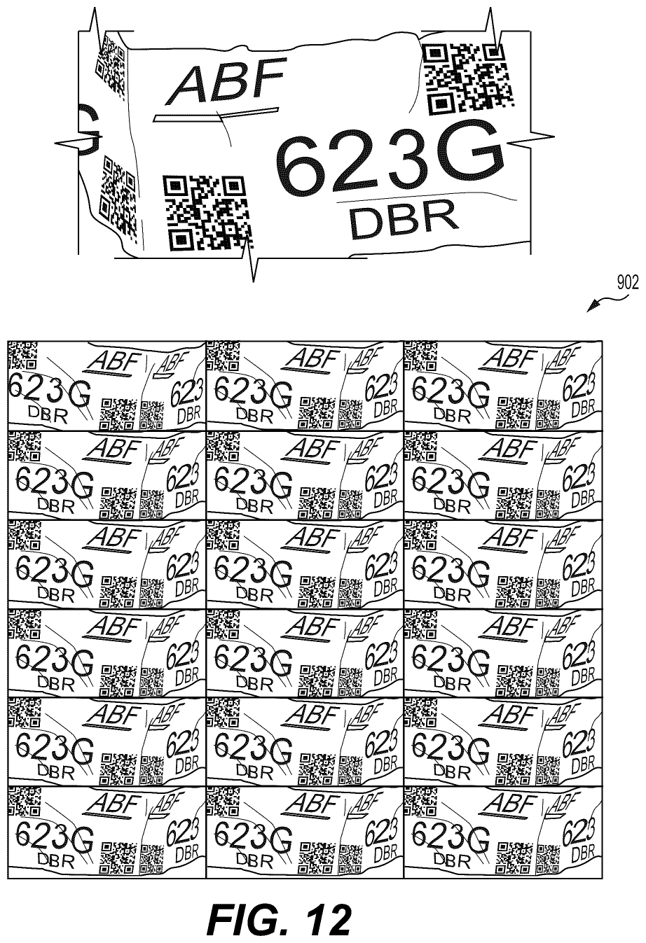

In some embodiments, the upper sensors 110 or lower sensors 112 may capture a plurality of digital images at predetermined intervals during each move event. From each of the gathered digital images, bounding boxes can be placed around detected objects for further processing. Like objects (e.g., objects in a similar region of the digital image) may be grouped into a collage. An example collage 902 of labels is depicted in FIG. 12.

An object detection module 124, trained on specific label formats, may be used to create collage 902 and detect labels. Every image in the collage 902 undergoes optical character recognition (OCR) which produces a plurality of label values. Other algorithms can be utilized to identify any machine-readable codes such as barcodes, data matrix codes, QR codes, etc. The values of the machine-readable codes can be decoded and the decoded information can be stored in association with the move event. Any resulting label values are ted and the most frequent label value is selected as the label identification for the freight 120. The freight ID can be added to the move event in association with the UUID for the move event. This collage approach allows for many opportunities to read the label while avoiding a large number of API calls and network bandwidth usage.

Label detection allows all of the move events for a particular piece of freight 120 to be correlated. This can be used to create a visual timeline of the freight 120 as it moves through the system and any of the data from the various move events can be compared as needed. For example, the arrival departure images from each move event can be compared to determine if any damage has occurred to the freight 120. The various dimensions from each move event can be compared as the freight 120 moves through the system. If there are changes in any dimension more than a predetermined threshold, a flag can be created for that particular piece of freight and sent to an administrator of PLDC system 100. Alternatively, the flag can be supplied directly to the UI 200 at the end of the move event. Changes in dimension may be indicative of freight damage, load shift, or missing freight. This allows damage or missing freight to be caught much earlier in the shipping process.

Further, if a label cannot be detected, the PLDC system 100 may prompt the forklift operator to manually scan the label on the freight 120. Even if the forklift operator must manually scan some labels, the overall manual work and downtime for scanning labels is reduced.

### Void Space Optimization

The final consolidated point cloud used may also be used to identify and quantify empty space available on the pallet holding freight 120. This information can be used to calculate efficiency metrics or perform load optimization.

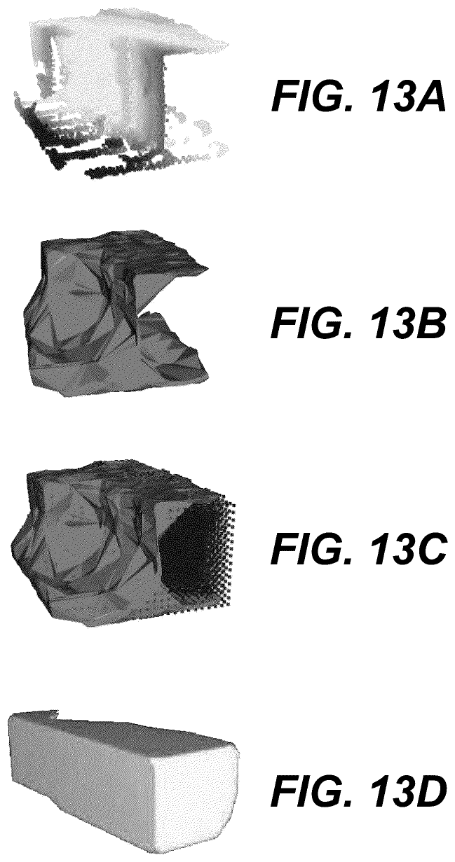

A primary obstacle when performing this calculation is that depth sensors only capture surface points of objects and can't see inside or behind them. Consequently, the “void space” in the point cloud may actually contain obscured objects. To distinguish these obstructed areas from genuine empty space, a mesh (FIG. 13B) is generated from the consolidated point cloud (FIG. 13A). This mesh, comprised of vertices, edges, and faces, approximates the visible surfaces of the freight 120 and helps identify areas obstructed from view.

Next, the cube area containing the freight 120 is filled with artificial points as depicted in FIG. 13C. Rays are then projected from each upper sensor 110 or lower sensor 112 to these artificial points. A point is deemed obstructed from view if none of the rays intersect the mesh of the freight 120. Conversely, all points not obstructed are verified as actual empty space as depicted in FIG. 13D. Because this method treats any obscured areas as filled, the resulting data provided by the system represents the minimum empty space on the pallet as depicted in FIG. 13D.

Finally, a mesh is generated from verified empty space points. The volume of this resulting mesh can then be calculated directly. This volume represents the visible empty space on the pallet (from the perspective of the upper sensors 110 and lower sensors 112).

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A piece level data collection (PLDC) system for determining dimensions of freight, the system comprising:
a PLDC server for wirelessly communicating with a plurality of conveyance vehicles;
a database for storing gathered dimensions of the freight; and
at least one conveyance vehicle of the plurality of conveyance vehicles for conveying the freight, the at least one conveyance vehicle comprising:
at least one upper sensor for gathering a first point cloud of the freight at a predetermined timing;
at least one lower sensor for gathering a second point cloud of the freight at the predetermined timing,
wherein the at least one upper sensor is positioned above the at least one lower sensor, and
wherein a vertical field of view of the at least one upper sensor overlaps with a vertical field of view of the at least one lower sensor; and
at least one computer processing unit (CPU) for combining the first point cloud and the second point cloud into a combined point cloud at each predetermined timing during a move event,
wherein the CPU determines the dimensions of the freight by:
determining if a personal space of the at least conveyance vehicle is occupied by the freight;
creating the move event if the personal space of the conveyance vehicle is occupied;
collecting the first point cloud and the second point cloud at each predetermined timing during the move event;
combining the first point cloud and the second point cloud into a combined point cloud at each predetermined timing;
for each combined point cloud at each predetermined timing, determining a plurality of dimensions of the freight,
wherein the plurality of dimensions comprises a length of the freight, a width of the freight, and a height of the freight,
averaging the plurality of dimensions to determine an average length of the freight, and average width of the freight, and an average height of the freight;
finalizing the move event to include final dimensions of the freight set to be the average length of the freight, the average width of the freight, and the average height of the freight; and
communicating the move event to the PLDC server for storage in the PLDC database.

2. The PLDC system according to claim 1, wherein the CPU further performs steps of:
prior to averaging the plurality of dimensions, removing any of the plurality of measurements more than three standard deviations for each dimension.

3. The PLDC system according to claim 1, wherein the CPU further performs steps of:
determining a rotation angle of the freight with respect to a coordinate system of the conveyance vehicle; and
correcting each combined point cloud using the determined rotation angle.

4. The PLDC system according to claim 1, further comprising:
at least one upper digital camera for imaging the freight at a second predetermined timing during the move event; and
at least one lower digital camera for imaging the freight during the move event at the second predetermined timing during the move event;
wherein the CPU adds at least one arrival image and one departure image to the move event captured by the at least one upper digital camera or the at least one lower digital camera.

5. The PLDC system according to claim 4, where the CPU further performs steps of:
analyzing the at least one arrival image and the at least one departure image to identify load shift or damage; and
adding load shift or damage information to the move event.

6. The PLDC system according to claim 4, wherein the CPU further performs steps of:
performing optical character recognition on the at least one arrival image and the at least one departure image to identify label information; and
adding any identified label information to the move event.

7. The PLDC system according to claim 1, further comprising:
at least one digital camera for imaging the freight at a second predetermined timing during the move event; and
assembling a collage of digital images collected by the at least one digital camera during the move event; and
adding the collage to the move event.

8. The PLDC system according to claim 7, wherein the CPU further performs steps of:
performing optical character recognition on each digital image in the collage to determine a plurality of label values; and
selecting a most frequent label value from the plurality of label values as a final label value; and
adding the final label value to the move event.

9. The PLDC system according to claim 7, wherein the CPU further performs steps of:
identifying any machine-readable codes in the collage;
decoding the identified machine-readable codes to determine the code content; and
adding the code content to the move event.

10. The PLDC system according to claim 1,
wherein the at least one upper sensor is a time-of-flight sensor, a light detection and ranging (Lidar) sensor, or a stereoscopic camera.

11. The PLDC system according to claim 1, further comprising,
a second upper sensor arranged on the conveyance vehicle at a same height as the at least one upper sensor,
wherein a horizontal field of view of the second upper sensor overlaps with a horizontal field of view of the at least one upper sensor.

12. The PLDC system according to claim 11, wherein a vertical field of view of the second upper sensor is greater than the horizontal field of view of the second upper sensor.

13. The PLDC system according to claim 1, wherein the at least one conveyance vehicle is a forklift, and
wherein the personal space is a bounding box comprising:
a height a same height as the forklift;
a width having a same width as tines of the forklift; and
a length extending from a mast of the forklift to a tip of the tines of the forklift.

14. The PLDC system according to claim 13, wherein the CPU determines if the personal space is occupied by:
determining a number of points in the combined point cloud at each predetermined timing;
comparing the number of points to a predetermined point threshold; and
setting the at least conveyance vehicle to a loaded state if the number of points is greater than or equal to the predetermine point threshold.

15. The PLDC system according to claim 14,
wherein the move event is created when the number of points is greater than or equal to the predetermined point threshold,
wherein the move event is ended when the number of points is less than the predetermined point threshold, and
wherein the CPU sets a start timestamp of the move event as a creation time of the move event; and
wherein the CPU sets an end time stamp of the move event when it is determined that the number of points is less than the predetermined point threshold.

16. The PLDC system according to claim 15, wherein the start time stamp and the end time stamp are added to the move event.

17. The PLDC system according to claim 1, wherein the at least one conveyance vehicle further comprises:
at least one display,
wherein the at least one display shows the final measurements for the freight at the end of the move event.

18. The PLDC system according to claim 17, wherein the displays an indicator message indicating if any of the plurality of measurements at the predetermined timing is greater than a first predetermined measurement threshold or less than a second predetermined measurement threshold.

19. The PLDC system according to claim 18, wherein the display provides instructions to adjust the freight if the indicator message is displayed.

20. The PLDC system according to claim 1, wherein a knee-based noise detection algorithm is utilized by the CPU to determine the length of the freight, the width of the freight, and the height of the freight at each predetermined timing.
